(19) United States
(12) Patent Application Publication
(10) Pub. No.: US 2010/0172371 A1
(43) Pub. Date: Jul. 8, 2010

(54) NETWORK SIGNAL PROCESSING APPARATUS AND SIGNAL PROCESSING METHOD THEREOF

(76) Inventors: Liang-Wei Huang, Taipei City (TW); Ta-Chin Tseng, Taipei County (TW); Ting-Fa Yu, Yunlin County (TW); Li-Wei Fang, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/684,121

(22) Filed: Jan. 8, 2010

(30) Foreign Application Priority Data
Jan. 8, 2009 (TW) 098100469

(51) Int. Cl. H04L 12/66

(52) U.S. Cl. 370/463

(57) ABSTRACT

A network signal processing apparatus includes: a transceiver for transmitting or receiving a network signal, and a transformer coupled to the transceiver and a network connecting port for transmitting or receiving the network signal. The transformer includes: a first coil, which is coupled to the transceiver and has a first turn number; and a second coil, which is coupled to the network connecting port and has a second turn number. The second turn number is different from the first turn number.

### BACKGROUND OF THE INVENTION

1. Field of the Invention

The present invention relates to a network signal processing apparatus and related method, and more particularly, to an apparatus for adjusting a transmitting power of an Ethernet signal and a method thereof.

2. Description of the Prior Art

In general, the longest guaranteed connection distance of an Ethernet or fast Ethernet is about 100 meters. When a connection distance is longer than 100 meters, the quality of the transmitting signal cannot be guaranteed. In a conventional implementation, if the connection distance of an Ethernet is to be elongated, a transmitting power of the transmitting signal has to be enhanced correspondingly. Increasing a supply voltage of an Ethernet transmitter is the most common way to enhance the transmitting power. However, as semiconductor processes progress, the supply voltage for integrated circuits becomes smaller such that the supply voltage of the Ethernet is bounded. That is, the supply voltage of the Ethernet transceiver cannot be increased unlimitedly to solve the problem of long-distance transmission.

### SUMMARY OF THE INVENTION

Therefore, one objective of the present invention is to provide a processing apparatus for adjusting a transmitting power of an Ethernet signal, and a related method.

According to an exemplary embodiment of the present invention, a network signal processing apparatus is provided. The network signal processing apparatus includes a transceiver and a transformer. The transceiver is for transmitting or receiving a network signal, and the transformer is coupled to the transceiver and a network connecting port, for transmitting or receiving the network signal. The transformer includes a first coil and a second coil. The first coil is coupled to the transceiver and has a first turn number. The second coil is coupled to the network connecting port and has a second turn number. The second turn number is different from the first turn number.

According to another exemplary embodiment of the present invention, a network signal processing method is provided. The steps of the network signal processing method include: providing a transceiver to transmit or receive a network signal; and providing a transformer between the transceiver and a network connecting port to transmit or receive the network signal. The transformer includes: a first coil, coupled to the transceiver and having a first turn number; and a second coil, coupled to the network connecting port and having a second turn number. The second turn number is different from the first turn number.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary embodiment of a network signal processing apparatus according to the present invention.

FIG. 2 is a flowchart illustrating an exemplary embodiment of an Ethernet signal processing method according to the present invention.

### DETAILED DESCRIPTION

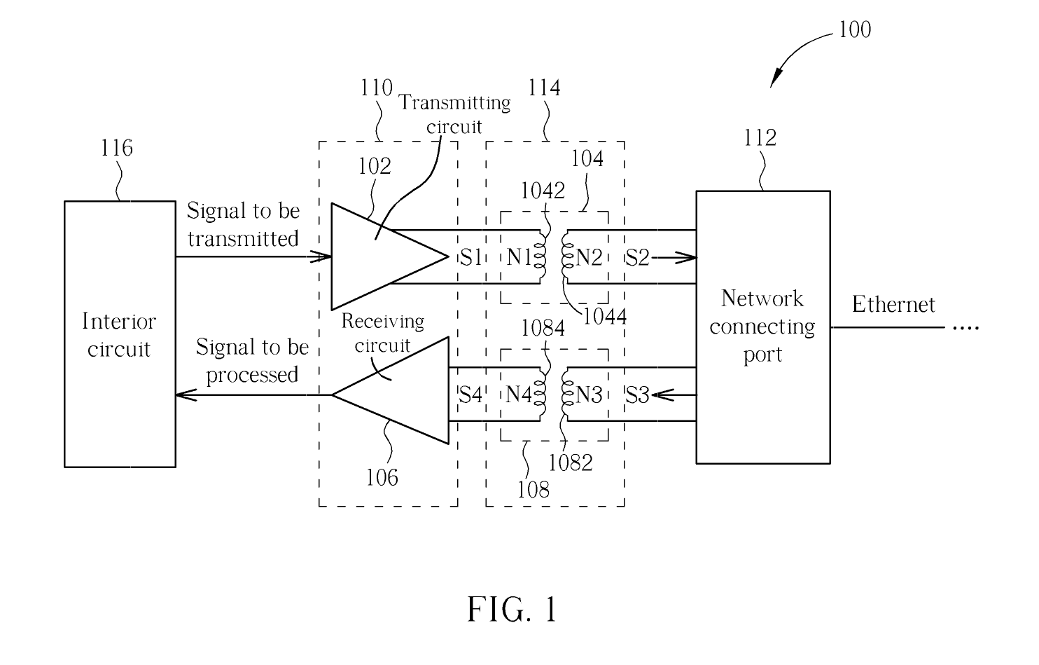

Please refer to FIG. 1. FIG. 1 is a diagram illustrating a network signal processing apparatus 100 according to an exemplary embodiment of the present invention. Please note that to further address the essence of the present invention, the network signal processing apparatus 100 is illustrated as a half-duplex network transceiver in this embodiment, but this is not meant to be a limitation to the scope of the present invention. The network signal processing apparatus 100 includes a transceiver 110, a transformer 114, an interior circuit 116 and a network connecting port 112. The transceiver 110 includes a transmitting circuit 102 and a receiving circuit 106. The transformer 114 comprises a first transformer 104 and a second transformer 108. The first transformer 104 includes a first coil 1042 and a second coil 1044. The first coil 1042 is coupled to the transmitting circuit 102, and has a first turn number N1. The second coil 1044 is coupled to the first coil 1042, and has a second turn number N2, wherein the second turn number N2 is larger than the first turn number N1. The second transformer 108 includes a third coil 1082 and a fourth coil 1084. The third coil 1082 has a third turn number N3. The fourth coil 1084 is coupled to the receiving circuit 106, and has a fourth turn number N4, wherein the fourth turn number N4 is larger than the third turn number N3, and the third coil 1082 does not connect with the second coil 1044 in series. In addition, the network connecting port 112 is coupled to the transformer 114, for transmitting network signal transmitted by the transmitting circuit 102 to an Ethernet, or transmitting network signal transmitted by the Ethernet to the receiving circuit 106. The network connecting port 112 could be an RJ45 network connecting port according to one embodiment of the present invention.

In the present invention, the transmitting circuit 102 will generate a first network signal S1 to the first coil 1042, and the second coil 1044 will then generate a second network signal S2 according to the first network signal S1. In addition, the third coil 1082 will receive a third network signal S3 transmitted by the network connecting port 112, and the receiving circuit 106 will then receive a fourth network signal S4 generated by the fourth coil 1084 according to the third network signal S3.

Therefore, when the transmitting circuit 102 generates the first network signal S1 with a first power P1 to the first coil 104 having the first turn number N1, the second coil 1044 having the second turn number will generate the second network signal S2 with a second power P2. Since the second turn number N2 is larger than the first turn number N1 in this embodiment (e.g., N2=3, and N1=1), the second power P2 of the second network signal S2 will be larger than the first power P1 according to the transformer theorem. From the aforementioned setting of the turn numbers, assuming that the peak-to-peak value of the first network signal S1 is 2V, the peak-to-peak value of the second network signal S2 will be amplified to be three times larger, i.e. 6V, in this embodiment. By increasing the second turn number N2 of the second coil 1044 to enhance the transmitting power, i.e., P2, the influence of channel fading on transmitted signal can be alleviated. In other words, the transmitting power of the Ethernet is enhanced by setting the turn number in the transformer 114. In this way, not only can the length of the network cable be elongated, but the power of the second network signal S2 received by the receiver at the other side of the Ethernet can also be increased, leading to an improvement of the quality of the signal received by the receiver.

In the same way, when the third coil 1082 receives the third network signal S3 with a third power P3, the fourth coil 1084 with the fourth turn number N4 will deduce the fourth network signal S4 with a fourth power P4. Since the fourth turn number N4 is larger than the third turn number N3 in this embodiment, e.g., N4=3, and N3=1, the fourth power P4 of the fourth network signal S4 will be larger than the third power P3. For example, assuming N4=2, and N3=1, the peak-to-peak amplitude of the fourth signal S4 could be amplified to be two times larger. Enhancing the power of the fourth network signal (i.e., P4) received by the receiving circuit 106 by increasing the turn number N4 of the fourth coil 1084 means that not only can the length of the network cable be elongated, but the influence of channel fading on received signal can also be alleviated, leading to an improvement of the quality of the signal received by the receiver.

In addition, the turn number N1, the turn number N2, the turn number N3 and the turn number N4 can be set according to a length of an Ethernet connection (i.e., the length of the network cable) to acquire a better signal quality. Since the first transformer 104 is for transmitting network signal to the Ethernet, and the second transformer 108 is for receiving network signal from the Ethernet, the function of the two transformers are different. Therefore, for transmitting network signal smoothly to the other side of the Ethernet and avoiding over-amplifying network noise received from the Ethernet, the turn ratios of the first transformer 104 and the second transformer 108 are set differently to achieve a better transmission quality according to a preferred embodiment. For example, N1:N2=1:4 and N3:N4=1:2. In other words, in the transformer 114, network signal to be transmitted to the Ethernet are amplified more (four times), and network signal received from the Ethernet are amplified less, leading to a better transmission quality.

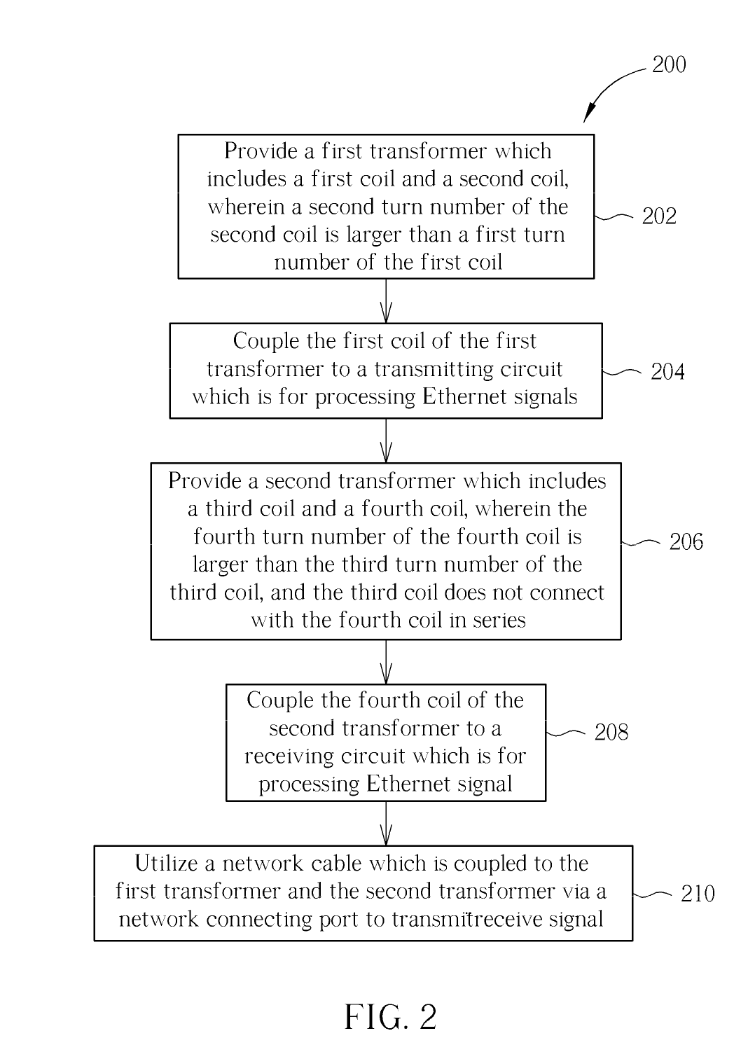

Please refer to FIG. 2. FIG. 2 is a flowchart of an Ethernet signal processing method 200 according to an exemplary embodiment of the present invention. To address the essence of the present invention more clearly, the signal processing method is explained in conjunction with the network signal processing apparatus 100 shown in FIG. 1; however, the provided embodiment is not meant to be a limitation to the present invention. In addition, if the result is substantially the same, the steps are not required to be executed in the exact order shown in FIG. 2; in addition, the steps shown in FIG. 2 are not necessarily executed sequentially, and other steps may also be placed in between. The flow of the signal processing method 200 includes the following steps:

Step 202: Provide a first transformer 104 which includes a first coil 1042 and a second coil 1044, wherein a second turn number N2 of the second coil 1044 is larger than a first turn number N1 of the first coil 1042;

Step 204: Couple the first coil 1042 of the first transformer 104 to a transmitting circuit 102 which is for processing Ethernet signal;

Step 206: Provide a second transformer 108 which includes a third coil 1082 and a fourth coil 1084, wherein the fourth turn number N4 of the fourth coil 1084 is larger than the third turn number N3 of the third coil 1082, and the third coil 1082 does not connect with the fourth coil 1084 in series;

Step 208: Couple the fourth coil 1084 of the second transformer 108 to a receiving circuit 106 which is for processing Ethernet signal; and

Step 210: Utilize a network cable which is coupled to the first transformer 104 and the second transformer 108 via a network connecting port 112 to transmit/receive signal.

Please refer to FIG. 1 and FIG. 2 simultaneously. In step 204 of the signal processing method 200, in order to ensure a higher power of the second network signal S2 which is transmitted to the Ethernet, the second coil 1044 with a larger turn number is coupled to the Ethernet while the first coil 1042 with a smaller turn number is coupled to the transmitting circuit 102. Likewise, in step 208, in order to ensure a higher power of the fourth network signal S4 which is received by the receiving circuit 106, the fourth coil 1084 with a larger turn number is coupled to the receiving circuit 106 while the third coil 1082 with a smaller turn number is coupled to the Ethernet. Therefore, the first turn number N1, the second turn number N2, the third turn number N3 and the fourth turn number N4 can be set according to a length of an Ethernet connection to acquire an optimum signal quality.

In addition, according to an embodiment of the present invention, the transceiver circuit 110 and the interior circuit 116 in the network signal processing apparatus 100 could be manufactured using a 65 nm process or a more advanced process to save circuit area. The transceiver circuit 110 could also operate with a supply voltage of 3.3 V or a supply voltage lower than 3.3 V to save power. Furthermore, assuming that the transceiver circuit 110 adopts a supply voltage of 3.3 V, the interior circuit 116 (e.g., a media access control circuit) configured for dealing with signal to be transmitted and signal to be processed could also adopt a supply voltage lower than 3.3V to save more power.

In summary, the present invention adjusts a turn ratio in a transformer to enhance a transmission distance of an Ethernet signal without substantially altering the interior design of a transceiver circuit. In addition, with proper design of the turn ratios to make a turn ratio of a transformer for transmitting network signal different from a turn ratio of a transformer for receiving network signal, a better signal quality can be achieved.

Those skilled in the art will readily observe that numerous modifications and alterations of the device and method may be made while retaining the teachings of the invention.

What is claimed is:

1. A network signal processing apparatus, comprising:
a transceiver for transmitting or receiving a network signal; and
a transformer, coupled to the transceiver and a network connecting port, for transmitting or receiving the network signal, wherein the transformer comprises:
a first coil, coupled to the transceiver, having a first turn number; and
a second coil, coupled to the network connecting port, having a second turn number;
wherein the second turn number is different from the first turn number.

2. The apparatus of claim 1, wherein the transceiver comprises a transmitting circuit configured for generating a first network signal to the first coil, the second coil generates a second network signal to the network connecting port according to the first network signal, and the second turn number is larger than the first turn number.

3. The apparatus of claim 1, wherein the transceiver comprises a receiving circuit configured for receiving a first network signal outputted from the first coil, and the second turn number is smaller than the first turn number.

4. The apparatus of claim 1, wherein the transformer further comprises:
a third coil, coupled to the transceiver, having a third turn number; and
a fourth coil, coupled to the network connecting port, having a fourth turn number;
wherein the fourth turn number is different from the third turn number, and the fourth coil is not connected with the second coil in series.

5. The apparatus of claim 4, wherein the transceiver further comprises:
a transmitting circuit, coupled to the first coil, for transmitting a first network signal to the first coil; and
a receiving circuit, coupled to the third coil, for receiving a second network signal from the third coil;
wherein the first turn number is less than the second turn number, and the third turn number is more than the fourth turn number.

6. The apparatus of claim 1, wherein the transceiver is implemented utilizing a semiconductor process which is more advanced than a 65 nm process.

7. The apparatus of claim 1, wherein the transceiver is operated with a supply voltage lower than 3.3 volts.

8. The apparatus of claim 1, further comprising:
an interior circuit, coupled to the transceiver, for processing the network signal;
wherein the transceiver is operated with a first supply voltage; the interior circuit is operated with a second supply voltage; and the second supply voltage is lower than the first supply voltage.

9. The apparatus of claim 8, wherein the interior circuit is a media access control circuit.

10. The apparatus of claim 1, wherein the network connecting port is an RJ45 network connecting port.

11. The apparatus of claim 1, being applied to an Ethernet.

12. A network signal processing method, comprising:
providing a transceiver for transmitting or receiving a network signal; and
providing a transformer between the transceiver and a network connecting port, for transmitting or receiving the network signal, wherein the transformer comprises:
a first coil, coupled to the transceiver, having a first turn number; and
a second coil, coupled to the network connecting port, having a second turn number;
wherein the second turn number is different from the first turn number.

13. The method of claim 12, wherein the transceiver utilizes a transmitting circuit to generate a first network signal to the first coil, the second coil generates a second network signal to the network connecting port according to the first network signal, and the second turn number is more than the first turn number.

14. The method of claim 12, wherein the transceiver utilizes a receiving circuit to receive a first network signal outputted from the first coil, and the second turn number is less than the first turn number.

15. The method of claim 12, wherein the transformer further comprises:
a third coil, coupled to the transceiver, having a third turn number; and
a fourth coil, coupled to the network connecting port, having a fourth turn number;
wherein the fourth turn number is different from the third turn number, and the fourth coil is not connected with the second coil in series.

16. The method of claim 15, wherein the transceiver comprises:
a transmitting circuit, coupled to the first coil, for transmitting a first network signal to the first coil; and
a receiving circuit, coupled to the third coil, for receiving a second network signal from the third coil;
wherein the first turn number is less than the second turn number, and the third turn number is more than the fourth turn number.

17. The method of claim 12, wherein the transceiver is implemented utilizing a semiconductor process which is more advanced than a 65 nm process.

18. The method of claim 12, further comprising:
providing a media access control circuit to process the network signal;
wherein the transceiver is operated with a first supply voltage; the media access control circuit is operated with a second supply voltage; and the second supply voltage is lower than the first supply voltage.

19. The method of claim 18, wherein the network connecting port is an RJ45 network connecting port.

20. The method of claim 18, being applied to an Ethernet.
